(19) United States
(12) Patent Application Publication
(10) Pub. No.: US 2014/0322495 A1
(43) Pub. Date: Oct. 30, 2014

(54) INTERIOR FILM COMPRISING THREE-DIMENSIONAL PATTERN, AND METHOD FOR PREPARING SAME

(71) Applicant: LG Hausys, Ltd., Seoul (KR)

(72) Inventors: Min-Ho Lee, Busan (KR); Jae-Gwang Nam, Busan (KR); Jung-Eun Ha, Changwon-si Gyeongsangnam-do (KR); Jun-Beom Shin, Suwon-si (KR)

(73) Assignee: LG HAUSYS ,LTD. a corporation

(21) Appl. No.: 14/358,405

(22) PCT Filed: Nov. 29, 2012
(86) PCT No.: PCT/KR2012/010216

§ 371 Date: May 15, 2014

(30) Foreign Application Priority Data
Dec. 1, 2011 (KR) 10-2011-0127536

(51) Int. Cl. B29C 45/14; B05D 3/06; B05D 1/30

(52) U.S. Cl. CPC B29C 45/14688; B05D 1/30; B05D 3/067; B29K 2995/0097
USPC 428/172; 264/447

(57) ABSTRACT

The present invention relates to an interior film comprising a UV curable resin layer, a metal layer, and an adhesive layer, wherein a three-dimensional pattern is formed on the UV curable resin layer. More specifically, various forms of high quality metal texture can be expressed by forming a three-dimensional pattern on the UV curable resin layer, and the three-dimensional pattern can be clearly and sophisticatedly implemented without collapsing by further comprising a top coating layer.

### TECHNICAL FIELD

The present invention relates to an interior film including a three-dimensional pattern and a method for preparing the same. More particularly, the present invention relates to a technique for forming a three-dimensional pattern on an upper side of a UV curable resin layer to express a variety of high quality metal textures.

### BACKGROUND ART

When a typical interior film is used as a surface material for mobile devices, such as mobile phones, notebooks and the like, and as molding type surface materials for electronic appliances, such as refrigerators, washing machines, air conditioners and the like, the typical interior film realizes various patterns and metal textures through gravure printing, but has a limit in realizing a three-dimensional pattern.

Korean Patent Laid-open Publication No. 10-2010-0048181 discloses only that a UV curable layer can be formed by curing a composition including a UV curable resin, a photostabilizer and an initiator through UV irradiation, and does not disclose a UV curable layer having an embossed pattern. Therefore, there is a need for an interior film for realization of three-dimensional and high quality decoration including various logos, patterns and the like.

### DISCLOSURE

### Technical Problem

It is an aspect of the present invention to provide an interior film, which includes various forms of three-dimensional high quality patterns and provides good elongation upon processing, and thus can be easily applied to various forms of injection-molded articles, and a method for preparing the same.

### Technical Solution

In accordance with one aspect of the present invention, an interior film includes a UV curable resin layer, a metal layer, and an adhesive layer, wherein the

UV curable resin layer includes a three-dimensional pattern formed on an upper side thereof.

In accordance with another aspect of the present invention, a method for preparing an interior film includes: forming a release layer on an upper side of a substrate; forming a top coating layer on an upper side of the release layer; forming a UV curable resin layer on an upper side of the top coating layer, and then forming a three-dimensional pattern on an upper side of the UV curable resin layer through a roll mold or a masking film, followed by UV curing; forming a printed layer on an upper side of the UV curable resin layer; depositing a metal layer on an upper side of the printed layer; and forming an adhesive layer on an upper side of the metal layer.

### Advantageous Effects

According to the present invention, the interior film can form various patterns, trademarks and logos with high quality textures and effects by forming a three-dimensional pattern on a UV curable resin layer, and can allow the three-dimensional pattern to be clearly and elaborately expressed through a top coating layer without collapsing.

In addition, the method for preparing an interior film includes forming a top coating layer, and forming a three-dimensional pattern on the UV curable resin layer, followed by UV curing, whereby the interior film can exhibit excellent formability due to high elongation upon processing, and can be applied to various forms of injection-molded articles.

### DESCRIPTION OF DRAWINGS

FIG. 1 shows an interior film according to one embodiment of the present invention.

FIGS. 2 and 3 show interior films according to other embodiments of the present invention.

FIG. 4 shows an interior film having a three-dimensional pattern prepared in Example.

### BEST MODE

The present invention provides an interior film including a UV curable resin layer on which a three-dimensional pattern is formed, and a method for preparing the interior film.

Hereinafter, embodiments of the present invention will be described in detail with reference to the accompanying drawings.

### Interior Film

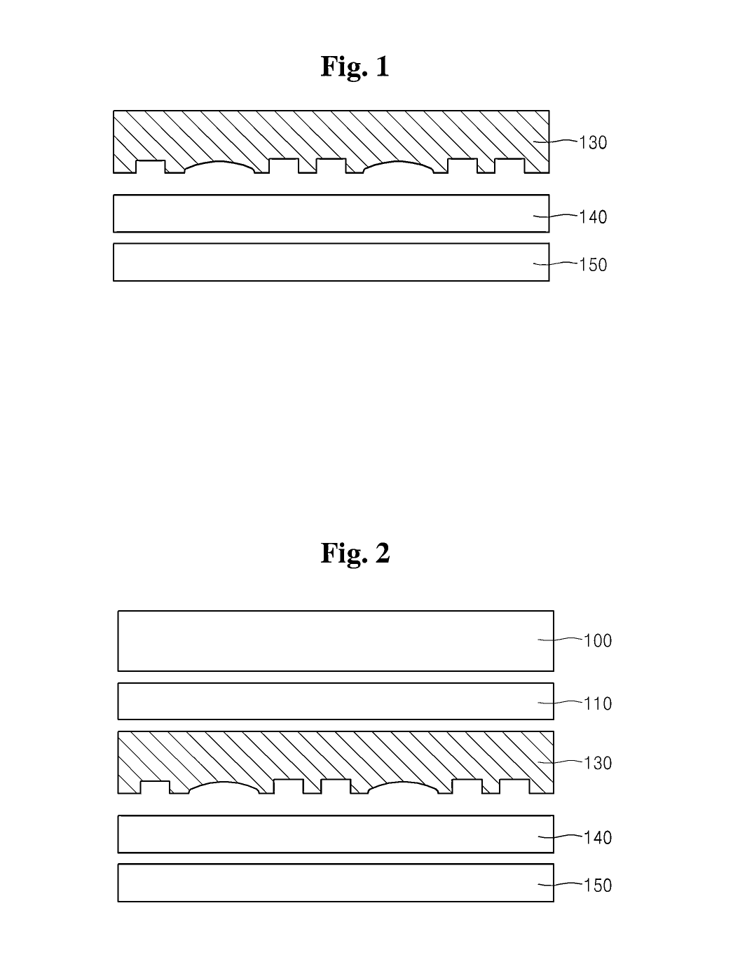

FIG. 1 shows an interior film according to one embodiment of the present invention.

Referring to FIG. 1, an interior film according to one embodiment includes a UV curable resin layer 130, a metal layer 140, and an adhesive layer 150, wherein the UV curable resin layer includes a three-dimensional pattern formed thereon.

According to the present invention, the UV curable resin layer 130 serves to protect the metal layer 140 and the adhesive layer 150. The UV curable resin layer 130 may be formed through UV irradiation of a composition, which includes a UV curable resin, a photostabilizer and an initiator. In addition, the UV curable resin layer 130 may be formed of a UV curable resin composition including at least one selected from among isobornyl acrylate and vinyl pyrrolidinone, as polyurethane or polyacrylate oligomers and monomers, a photoinitiator, and a photostabilizer. Further, the UV curable resin composition may include additives for supplementing properties thereof so long as the additives do not adversely affect properties of the UV curable resin composition.

More specifically, the UV curable resin composition may include 30 parts by weight to 90 parts by weight of the oligomer, 10 parts by weight to 50 parts by weight of the monomer, 1 part by weight to 10 parts by weight of the photoinitiator, and 0.2 parts by weight to 5 parts by weight of the photostabilizer. If the oligomer is present in an amount of less than 30 part by weight, the UV curable resin layer can be easily broken due to low molecular weight and brittleness, and if the oligomer is present in an amount of greater than 90 part by weight, the UV curable resin composition can suffer from deterioration in processability due to high molecular weight and increase in viscosity. In addition, if the monomer is present in an amount of less than 10 part by weight, the UV curable resin composition can suffer from deterioration in processability due to high viscosity thereof, and if the monomer is present in an amount of greater than 50 part by weight, the UV curable resin composition has low molecular weight and can suffer from deterioration in elasticity, elongation and heat resistance due to low viscosity, despite good processability. If the photoinitiator and the photostabilizer are present in amounts not within the aforementioned ranges, the UV curable resin composition can suffer from deterioration in heat resistance, solvent resistance, and other properties due to deterioration in curing of the photoinitiator.

The UV curable resin composition may be free from a solvent to form the same pattern as the pattern formed on a mold, such as an embossing roll. The UV curable resin layer 130 may be formed in consideration of thickness of the three-dimensional pattern formed thereon.

The UV curable resin composition advantageously exhibits little or no adhesion to metal and lower side tension to improve adhesion to and releasability from another layer, which may be further formed on the upper side of the UV curable resin layer 130 and will be described below.

When a silicone and/or fluorine fatty acid additive is used to reduce the surface tension of the UV curable resin composition, the UV curable resin composition has improved releasability. In addition, a lower glass transition temperature (Tg) of the oligomer is better for releasability of the UV curable resin composition, and use of a resin having a low glass transition temperature (Tg) can improve releasability of the resin composition. However, when an excess of the silicone or fluorine additive is used, adhesion of the UV curable resin layer to a substrate can be deteriorated. Thus, the silicone or fluorine additive should be used in a suitable amount.

In addition, since a cured resin exhibits higher surface hardness with increasing crosslinking degree, it is necessary for the monomer included in the UV curable resin composition to have a multi-functional group. However, since a higher number of functional groups can cause deterioration in dimensional stability, elongation and flexibility, it is necessary for the monomer to have a suitable number of functional groups.

The photoinitiator included in the UV curable resin composition may be a typical photoinitiator, for example, Irgacure 184, and may be used in conjunction with the photostabilizer, such as a Tinuvin 400.

Further, the UV curable resin layer 130 including the UV curable resin composition may be formed by various methods, such as nip coating, bar coating, and the like. Preferably, the UV curable resin layer 130 is formed by micro gravure coating.

The UV curable resin layer 130 may have a thickness of 5 μm to 20 μm. If the thickness of the UV curable resin layer 130 is less than 5 μm, the three-dimensional pattern can be deteriorated in a sense of depth, and if the thickness of the UV curable resin layer 130 is greater than 20 μm, a curved surface can suffer from cracking during formation of the curved surface.

According to the invention, the UV curable resin layer 130 includes the three-dimensional pattern thereon. Here, the three-dimensional pattern is formed to a thickness of 5 μm to 20 μm, thereby providing sufficient three-dimensional effects and adhesion. That is, if the thickness of the three-dimensional pattern is less than 5 μm, the three-dimensional pattern cannot obtain sufficient three-dimensional effects, and cannot secure coupling effects with the metal layer formed after formation thereof. In addition, if the thickness of the three-dimensional pattern is greater than 20 μm, the total thickness of the interior film is increased, and in-mold transfer cannot be normally performed due to deterioration in formability when the interior film is used as an in-mold film.

The three-dimensional pattern may include hairline patterns, embossed or engraved trademarks, logos, and the like, without being limited thereto. The hairline pattern may be formed to a thickness of 0.2 μm to 2 μm, and the embossed or engraved pattern may be formed to a thickness of 2 μm to 20 μm. If the thickness of the hairline pattern is not within this range, the hairline pattern can be deteriorated in precision and if the thickness of the embossed or engraved pattern is not within this range, there can be a problem of deterioration in diffuse reflection effects.

According to the invention, the interior film includes the metal layer 140 on a surface of the three-dimensional pattern formed on the upper side of the UV curable resin layer 130. Here, the metal layer 140 may be formed of at least one selected from among aluminum, copper and titanium by sputtering. In addition, the metal layer 140 is formed to a thickness of 200 nm to 800 nm.

If the thickness of the metal layer 140 is less than 200 nm, sufficient metal texture cannot be obtained, and if the thickness of the metal layer 140 is greater than 800 nm, a unique texture which can be obtained by the three-dimensional pattern can be lost, and there can be a problem of deterioration in formability due to the increased thickness of the metal layer.

In addition, the metal layer 140 may further include a background printed layer which may have a color other than a unique metal color. In this case, only a region, such as a logo and the like, which requires a metal texture, is subjected to sputtering, and the background printed layer may be formed on the remaining region by a process of forming the printed layer.

Next, the adhesive layer 150 is formed on the upper side of the metal layer 140 to facilitate bonding of the interior film to an injection-molded article when the interior film is used as an in-mold transfer film. Here, the metal layer 140 has an uneven surface due to the three-dimensional pattern.

The adhesive layer 150 is formed of an acrylic or vinyl adhesive by gravure printing. By the adhesive layer 150, the surface of the metal layer 140 can be naturally flattened, and bonding the interior film to a product or the like can also be facilitated.

In addition, the adhesive layer 150 may have a thickness of 1 μm to 10 μm. If the thickness of the adhesive layer 150 is less than 1 μm, there can be a problem of deterioration in adhesion between the metal layer 140 and the injection-molded article, and if the thickness of the adhesive layer 150 is greater than 10 μm, the injection-molded article can suffer from printing flow marks on an upper side thereof.

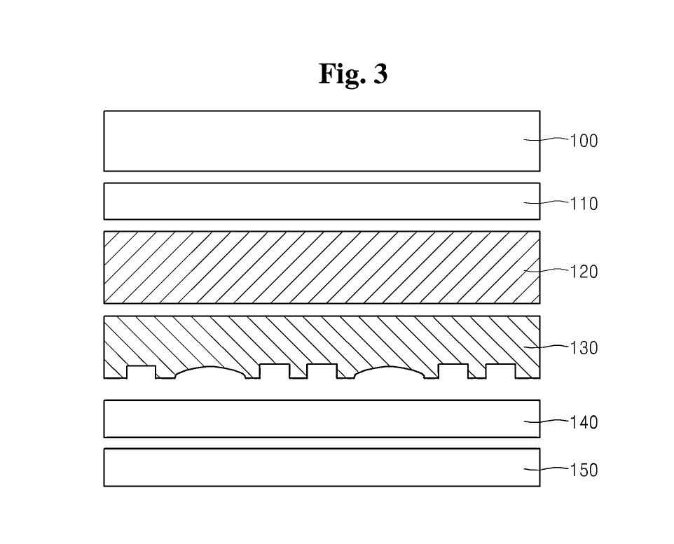

Referring to FIG. 2, an interior film according to another embodiment of the invention includes a substrate 100, a release layer 110, a UV curable resin layer 130, a metal layer 140, and an adhesive layer 150. In this embodiment, the interior film includes the substrate 100 and the release layer 110 on a lower side of the UV curable resin layer.

The substrate 100 serves to maintain an overall shape of the interior film. The substrate may be a heat resistant synthetic resin, and include at least one resin selected from among polyester, polypropylene, polyamide, polyethylene, triacetate resins, and mixtures thereof.

In particular, the substrate is preferably prepared using polyethylene terephthalate (PET) or polyethylene terephthalate glycol (PETG) among polyester resins. The polyethylene terephthalate or polyethylene terephthalate glycol has a higher elongation than those of typical substrate materials, thereby improving formability of the interior film according to the invention.

In addition, the substrate 100 may have a thickness of 20 μm to 200 μm. If the thickness of the substrate 100 is less than 20 μm, it is difficult to process the substrate due to high film shrinkage, and if the thickness of the substrate 100 is greater than 50 μm, there can be a difficulty in forming a curved surface upon injection molding.

The release layer 110 serves to separate the substrate 100 from an injection-molded article after injection molding. The release layer 110 may include at least one selected from acrylic, urethane, melamine, fluorine, and silicone resins, and mixtures thereof. In particular, the release layer 110 preferably includes a melamine or silicone resin. Since the melamine or silicone resin can be coated to a thin thickness in a liquid state, the melamine or silicone resin is suitable as a material for bonding the substrate 100 to the top coating layer 120, and when the UV curable resin layer 130 is completely cured, the release layer 110 can allow the substrate 100 and the UV curable resin layer 130 to be easily separated from each other.

The release layer 110 may have a thickness of 0.5 μm to 10 μm. If the thickness of the release layer 110 is less than 0.5 μm, there can be a problem that the substrate 100 is not easily removed or is not peeled off at all after injection molding, and if the thickness of the release layer 110 is greater than 10 μm, the interior film can suffer from burr since unnecessary portions can also be transferred due to easy peeling of the substrate.

Referring to FIG. 3, an interior film according to a further embodiment may further include a top coating layer 120. Here, the interior film includes the top coating layer 120 on a lower side of the UV curable resin layer 130. As shown in FIG. 3, when the top coating layer 120 is disposed between the release layer 110 and the UV curable resin layer 130, the interior film may include, from top to bottom, the substrate 100, the release layer 110, the top coating layer 120, the UV curable resin layer 130, the metal layer, and the adhesive layer 150.

The top coating layer 120 maintains surface properties and chemical resistance of the interior film even after removal of the release layer 110 and reinforces fouling resistance and abrasion resistance of the UV curable resin layer including the three-dimensional pattern, thereby further improving three-dimensional effects.

In addition, the top coating layer 120 has a thickness of 1 μm to 20 μm. If the thickness of the top coating layer 120 is less than 1 μm, the interior film can be deteriorated in surface hardness and abrasion resistance, and if the thickness of the top coating layer 120 is greater than 20 μm, the interior film can suffer from cracking during thermoforming due to the excessive thickness thereof. In particular, if the top coating layer 120 has a thickness of less than 8 μm, the top coating layer can be deteriorated in properties, and if the top coating layer 120 has a thickness of greater than 12 μm, the interior film can be deteriorated in post-processing workability, such as molding and injection molding workability, and the like. Thus, the top coating layer 120 preferably has a thickness of 8 μm to 12 μm.

The top coating layer 120 may be formed by micro gravure coating, comma coating, or slot die coating. In particular, when the top coating layer has a viscosity of less than 200 cPs, it is advantageous to use micro gravure coating, and when the top coating layer has a viscosity of greater than 200 cPs, it is advantageous to use comma coating.

In micro gravure coating, since a coating target and a gravure roll are moved in opposite directions, the coating target is coated with a coating liquid on the gravure roll while the coating target is not significantly bent by the gravure roll without pressing the coating target at an opposite side to the gravure roll using a separate rubber roll or the like. Since micro gravure coating allows easy adjustment of the amount of the coating liquid and uniform coating without wrinkling, micro gravure coating is broadly used in the art.

In comma coating, a roll is secured and a coating material is moved in an opposite direction to a traveling direction of a coating target while adjusting the thickness of the coating material. Comma coating has high precision and allows easy adjustment of coating thickness. In addition, comma coating enables easy cleaning upon replacement of the coating liquid, and provides excellent smoothness to a coating surface.

The top coating layer 120 is formed of a coating liquid including a solid photocurable compound, an acrylic resin, and a fluorine additive.

According to the invention, the solid photocurable compound may be any solid photocurable compound generally used in the art without limitation so long as the solid photocurable compound includes a photosensitive group which can be cross-linked by irradiation. For example, the solid photocurable compound may include monomers and prepolymers of compounds having at least one ethylene unsaturated double bond, oligomers such as dimmers, terpolymers and the like, mixtures thereof, copolymers thereof, and the like. In addition, the solid photocurable compound may include typical solid photocurable compounds known in the art, such as polyurethane, epoxy, polyester, polyether, alkyd, polyvinyl chloride, fluorinated, silicone, vinyl acetate, novolac resins, resin compositions in which at least two of these resins are bonded to at least one photopolymerizable unsaturated group, compounds in which a photopolymerizable unsaturated group is bonded to a modified resin containing at least two of these resins, and the like. Examples of the photopolymerizable unsaturated group may include acryloyl, methacryloyl, vinyl, styryl, allyl, cinnamoyl, cinnamylidene, azide groups, and the like.

The acrylic resin may be any acrylic resin having at least one double bond, such as methyl methacrylate, urethane acrylate, epoxy acrylate, silicone acrylate, ethylhexyl acrylate, butyl acrylate, ethyl acrylate, isobornyl acrylate, cyclohexyl methacrylate, glycidyl methacrylate, glycidyl acrylate, biphenyl acrylate, ethyl acrylate, lauryl acrylate, stearyl acrylate, acrylic acid, hydroxyethyl acrylate, hydroxybutyl acrylate, hydroxyethyl methacrylate, phenoxy acrylate, methylacrylate, hexanediol diacrylate, and the like. The acrylic resin may be used by polymerizing the acrylic resin in a polymeric form, by mixing the acrylic resin in a monomer form with a polymerized resin in a polymeric form, or by mixing polymerized polymer with a solvent. In addition, the acrylic resin may be suitably selected from among acrylic resins exhibiting transparency so as not to deteriorate visibility of a display.

The fluorine additive may include a reactive monomer or oligomer having a fluorine group. For example, the fluorine additive may be any one selected from among fluoroalkyl group-containing vinyl compounds, fluoroalkyl group-containing (meth)acrylate compounds, and fluorine polyacrylate, without being limited thereto.

In addition, the solvent may include benzene, toluene, methylethylketone, methyl isobutyl ketone, acetone, ethanol, tetrahydrofurfuryl alcohol, propyl alcohol, propylene carbonate, N-methyl pyrrolidinone, N-vinyl pyrrolidinone, N-acetyl pyrrolidinone, N-hydroxymethyl pyrrolidinone, N-butyl pyrrolidinone, N-ethyl pyrrolidinone, N-(N-octyl) pyrrolidinone, N-(N-dodecyl) pyrrolidinone, 2-methoxyethyl ether, xylene, cyclohexane, 3-methyl cyclohexanone, ethyl acetate, butyl acetate, tetrahydrofuran, methanol, amyl propionate, methyl propionate, propylene glycol methyl ether, diethylene glycol monobutyl ether, dimethyl sulfoxide, dimethyl formamide, ethylene glycol, hexafluoroantimonate, monoalkyl ether of ethylene glycol, dialkyl ether of ethylene glycol, cellosolve derivatives, and mixtures thereof.

The type and amount of the solvent may be suitably selected in consideration of properties, such as smoothness of the top coating layer, corrosion of the substrate by the solvent, adhesion, haze, pin hole, and the like.

Further, the coating liquid of the top coating layer may include 30 parts by weight to 50 parts by weight of the acrylic resin and 0.1 parts by weight to 5 parts by weight of the fluorine additive, based on 100 parts by weight of the solid photocurable compound. The acrylic resin allows easy coating and exhibits excellent solubility in an organic solvent. In addition, the acrylic resin is particularly advantageous in terms of film strength and molding processability after film formation. If the acrylic resin is present in an amount of less than 30 parts by weight, the interior film can suffer from cracking upon thermoforming, and if the acrylic resin is present in an amount of greater than 50 parts by weight, the interior film can be deteriorate in chemical resistance and hardness. Furthermore, if the amount of the fluorine additive is not within the aforementioned range, the interior film can suffer from deterioration in fingerprint resistance.

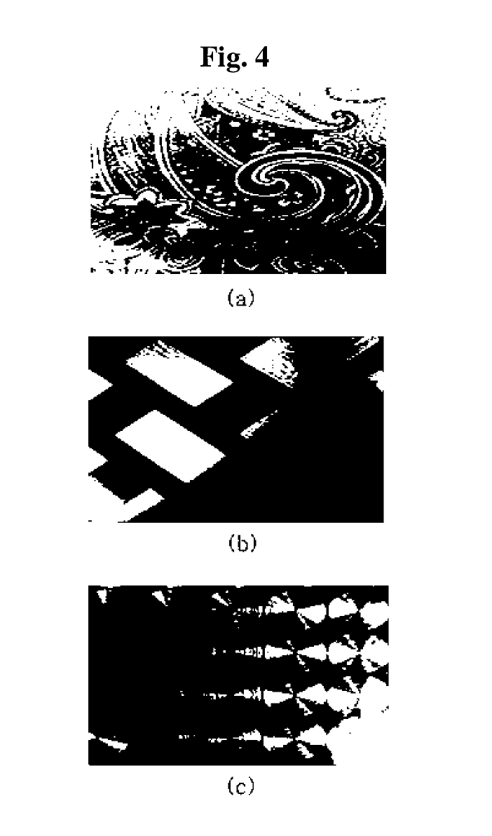

FIG. 4 shows an interior film having a three-dimensional pattern according to Example.

In the interior film of FIG. 4, a three-dimensional pattern 150 includes an embossed or engraved surface formed using a transparent ink, and a high quality metal texture is formed by realizing a hairline pattern on the engraved surface.

When the three-dimensional pattern is formed in practice, the hairline pattern is formed after the engraved surface is printed in reverse, and when the interior film including the three-dimensional pattern is applied to an injection-molded article, the injection-molded article has an embossed surface. Although the interior film includes the three-dimensional pattern on the overall surface thereof in this example, the interior film may include the three-dimensional pattern partially formed on the surface thereof, and the three-dimensional pattern may be expressed by sequentially forming the engraved surface and the printed layer.

Such an interior film according to the present invention may be used as an in-mold transfer film. The in-mold transfer film provides extremely important influence on quality of a molded article in in-mold injection molding, and generally includes, from bottom to top, a base film having releasability, a protective layer, a printed layer having a predetermined pattern, and an adhesive layer. However, when the interior film according to the invention is used as the in-mold transfer film, the interior film includes the UV curable resin layer having the three-dimensional pattern thereon, and thus can realize a wider variety of two-dimensional and three-dimensional patterns than typical in-mold transfer films.

### Method for Preparing Interior Film

According to the present invention, a method for preparing an interior film includes: forming a release layer 110 on an upper side of a substrate 100; forming a top coating layer 120 on an upper side of the release layer 110; forming a UV curable resin layer 130 on an upper side of the top coating layer 120, and then forming a three-dimensional pattern on an upper side of the UV curable resin layer through a roll mold or a masking film, followed by UV curing; depositing a metal layer 140 on an upper side of the UV curable resin layer 130; and forming an adhesive layer 150 on an upper side of the metal layer 140.

In particular, since the three-dimensional pattern is formed on the upper side of the UV curable resin layer 130 through the roll mold or the masking film, a continuous process is possible and provides a seamless three-dimensional pattern unlike the case of using an embossing belt or roller. Thus, the three-dimensional pattern can be naturally realized on the upper side of the UV curable resin layer 130. A method for forming each of these layers is the same as the method described above.

As described above, the method for preparing an interior film according to the invention allows the interior film to express a pattern, on which the three-dimensional pattern is projected, by forming the top coating layer on the upper side of the UV curable resin layer, followed by forming the three-dimensional pattern on the UV curable resin layer, thereby allowing various forms of patterns, trademarks and logos to be easily expressed in a luxurious style on outer appearances of electronic products.

In addition, since the interior film according to the invention employs the top coating layer and the UV curable resin layer which are subjected to surface treatment, the interior film can exhibit high elongation. In particular, the interior film exhibiting excellent formability is an in-mold transfer film, and since the release layer is clearly separated after in-mold transfer, the interior film allows convenience operation while improving productivity.

Hereinafter, the present invention will be explained in more detail with reference to some examples. It should be understood that these examples are provided for illustration only and are not to be construed in any way as limiting the present invention.

### EXAMPLE

A thermoformable polyethylene terephthalate film was used as a substrate, and to form a release layer on one surface of the 50 μm thick polyethylene terephthalate film (Toray Co., Ltd., Japan), 2 parts by weight of an isocyanate curing agent was mixed with 100 parts by weight of a solution in which an acrylic resin was dissolved in methylethylketone such that the solution had a solid content of 35%, thereby forming a 2 μm thick release layer. To form a top coating layer on an upper side of the release layer, 30 parts by weight of urethane acrylate, 5 parts by weight of epoxy isocyanate, 18 parts by weight of toluene, 45 parts by weight of methylethylketone (MEK) and 2 parts by weight of a methacrylic fluorocarbon additive were mixed based on 100 parts by weight of a solid photocurable compound, thereby forming a 10 μm thick top coating layer through micro gravure coating.

To form a UV curable resin layer on an upper side of the top coating layer, a UV curable resin composition including 50 parts by weight of a polyacrylate oligomer, 30 parts by weight of an isobornyl acrylate monomer, 3 parts by weight of Irgacure 184 and 3 parts by weight of Tinuvin 400 was injected between an embossing roll and a gap roll (steel roll or rubber roll), followed by UV curing, thereby forming a UV curable resin layer on the upper side of the top coating layer. Then, a three-dimensional pattern was formed on an upper side of the UV curable resin layer. The UV curable resin layer had a thickness of 15 μm.

Next, aluminum was deposited to a thickness of 600 nm on a lower side of the UV curable resin layer, followed by forming an ester adhesive layer to a thickness of 3 μm, thereby preparing an in-mold transfer film.

1. An interior film comprising:
a UV curable resin layer;
a metal layer; and
an adhesive layer,
wherein the UV curable resin layer comprises a three-dimensional pattern on an upper side thereof.

2. The interior film according to claim 1, comprising: a substrate or a release layer on a lower side of the UV curable resin layer.

3. The interior film according to claim 1, further comprising: a top coating layer on a lower side of the UV curable resin layer.

4. The interior film according to claim 1, wherein the interior film is an in-mold transfer film.

5. The interior film according to claim 3, wherein the top coating layer has a thickness of 1 μm to 20 μm.

6. The interior film according to claim 3, wherein the top coating layer is formed by micro gravure coating or comma coating.

7. The interior film according to claim 3, wherein the top coating layer is formed of a coating liquid comprising a solid photocurable compound, an acrylic resin and a fluorine additive.

8. The interior film according to claim 7, wherein the coating liquid comprises 30 parts by weight to 50 parts by weight of the acrylic resin, and 0.1 parts by weight to 5 parts by weight of the fluorine additive, based on 100 parts by weight of the solid photocurable compound.

9. The interior film according to claim 2, wherein the substrate comprises at least one selected from among polyester, polypropylene, polyamide, polyethylene, and triacetate resins, and has a thickness of 20 μm to 200 μm.

10. The interior film according to claim 2, wherein the release layer comprises at least one selected from among acrylic, urethane, melamine, fluorine and silicone resins, and has a thickness of 0.5 μm to 10 μm.

11. The interior film according to claim 1, wherein the UV curable resin layer is formed of a UV curable resin composition comprising at least one selected from among isobornyl acrylate and vinyl pyrrolidinone, as a polyurethane or polyacrylate oligomer and monomer, a photoinitiator, and a photo stabilizer.

12. The interior film according to claim 11, wherein the UV curable resin composition comprises 30 parts by weight to 90 parts by weight of the oligomer, 10 parts by weight to 50 parts by weight of the monomer, 1 part by weight to 10 parts by weight of the photoinitiator, and 0.1 parts by weight to 5 parts by weight of the photostabilizer.

13. The interior film according to claim 1, wherein the UV curable resin layer has a thickness of 5 μm to 20 μm.

14. The interior film according to claim 1, wherein the three-dimensional pattern has a thickness of 5 μm to 20 μm.

15. The interior film according to claim 12, wherein the three-dimensional pattern comprises a hairline pattern having a thickness of 0.2 μm to 2 μm, and an embossed or engraved pattern having a thickness of 2 μm to 20 μm.

16. The interior film according to claim 1, wherein the metal layer comprises at least one selected from among aluminum, copper and titanium, and has a thickness of 200 nm to 800 nm.

17. The interior film according to claim 1, wherein the adhesive layer has a thickness of 1 μm to 10 μm.

18. A method for preparing an interior film, comprising:
forming a release layer on an upper side of a substrate;
forming a top coating layer on an upper side of the release layer;
forming a UV curable resin layer on an upper side of the top coating layer, and then forming a three-dimensional pattern on an upper side of the UV curable resin layer through a roll mold or a masking film, followed by UV curing;
depositing a metal layer on an upper side of the UV curable resin layer; and
forming an adhesive layer on an upper side of the metal layer.
